(19) United States
(12) Patent Application Publication
(10) Pub. No.: US 2006/0109759 A1
(43) Pub. Date: May 25, 2006

(54) Method for determining optimum recording power using gamma curve

(75) Inventor: Jin-woo Yun, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/227,081

(22) Filed: Sep. 16, 2005

(30) Foreign Application Priority Data
Oct. 8, 2004 (KR) 10-2004-0080182

(51) Int. Cl. G11B 7/00; G11B 5/09

(52) U.S. Cl. 369/47.5; 369/59.11; 369/116

(57) ABSTRACT

A method for determining an optimum recording power by using the analysis of a gamma curve, includes the steps of receiving a data recording start command; determining an area to conduct an optimum power control (OPC) procedure by examining a count area in a power calibration area (PCA) of an optical recording medium, and recording an eight-to-fourteen modulation (EFM) signal on a test area included in the PCA; calculating a modulation amplitude based on a maximum level of a light intensity and a minimum level of a light intensity that are obtained by sampling a RF signal generated when test data being written on the PCA several times are retrieved in sequence, and estimating a modulation amplitude curve from the modulation amplitude using a curve fitting; deriving a gamma curve from the modulation amplitude curve, and determining whether the derived gamma curve corresponds to a higher-order function curve beyond a cubic function curve; and determining an optimum recording power based on the gamma curve when the gamma curve corresponds to a function curve below a cubic function curve. If the gamma curve obtained through the OPC procedure corresponds to a higher-order function curve over a cubic function, the presence of the noise is determined and the OPC procedure is re-conducted. Therefore, it is possible to determine the optimum recording power with more accuracy during the OPC procedure.

### CROSS-REFERENCE TO RELATED APPLICATIONS

This application claims the benefit of from Korean Patent Application No. 2004-80182, filed on Oct. 8, 2004 in the Korean Intellectual Property Office, the disclosure of which is incorporated herein by reference.

### BACKGROUND OF THE INVENTION

1. Field of the Invention

The present invention relates generally to a method for determining an optimum recording power. More specifically, the present invention relates to a method for determining an optimum recording power with high accuracy by analyzing a gamma curve.

2. Description of the Related Art

Optical recording media can be categorized into three types based on the data rewritability, that is, a read only memory (ROM) type, a write once read many (WORM) type, and a rewritable type.

The ROM-type optical recording media includes compact disk (CD) ROMs and digital versatile disk (DVD) ROMs. The WORM-type optical recording media include recordable compact disks (CD-Rs) and DVDRs, which allow information to be written on the disk only once.

The rewritable optical media, which allow repeated recording on the disk, include rewritable compact disks (CD-RWs) and DVD-RWs.

To record data on the optical recording media with high recording quality, an optimum power control (OPC) process is required to determine an optimum recording power with respect to recorders and disks having different optical characteristics. Typically, the OPC procedure is conducted on a power calibration area, which is a special reserved area on the disk, as described in the Orange Book.

Optical recording and reproducing devices for the CD-type and DVD-type optical disks write information on optical disks by irradiating a laser beam having a relatively high-powered energy that is enough to change a physical characteristic of an information recording layer. To reproduce information from the optical disks, the optical recording and reproducing devices irradiate a laser beam having a relatively low-powered energy so as not to change the physical characteristic.

In short, the information is written by driving a laser diode (LD) with a higher recording power and by forming pits on the optical disk. The pit formation with a preset length on the disks is referred to as write strategies.

The incident laser beam hits the reflective surface where the pits are formed. Accordingly, the pits appear like raised bumps from the viewpoint of the incident laser beam. The width of the pit ranges 0.4˜0.6 μm. The pit length and the intervals between pits on the CD-type disks range from 3T to 11T, and those of the DTD-type disks range from 3T to 14T. T is a length of one clock pulse. Thus, 3T is the length of three clock pulses, and 11T is the length of eleven clock pulses.

When writing information on recordable optical disks such as DVD-R/RWs, optical disk recording and reproducing devices perform the optimum power control (OPC) to determine the most suitable recording power for given disks. To this end, a power calibration area (PCA) is reserved at the innermost area on the recordable optical disks as a test area to determine the recording power.

In view of the related art, however, it is hard to accurately determine the optimum recording power due to the presence of noise when the pickup characteristic is inferior, or a tracking servo or a focusing servo becomes instable during the OPC procedure.

### SUMMARY OF THE INVENTION

The present invention has been provided to solve the above-mentioned and other problems and disadvantages occurring in the conventional arrangement, and an aspect of the present invention provides a method for determining an optimum recording power with higher accuracy by analyzing a gamma curve during an optimum power control (OPC) procedure that is performed only when a pickup characteristic is good, and a tracking servo and a focusing servo are stable.

The foregoing and/or other aspects of the present invention are achieved by providing a method for determining an optimum recording power by using the analysis of a gamma curve, including receiving a data recording start command, determining an area to conduct an optimum power control (OPC) procedure by examining a count area in a power calibration area (PCA) of an optical recording medium, and recording an eight-to-fourteen modulation (EFM) signal on a test area included in the PCA, calculating a modulation amplitude based on a maximum level of a light intensity and a minimum level of a light intensity that are obtained by sampling a RF signal generated when test data being written on the PCA several times are retrieved in sequence, and estimating a modulation amplitude curve from the modulation amplitude using a curve fitting, deriving a gamma curve from the modulation amplitude curve, and determining whether the derived gamma curve corresponds to a higher-order function curve beyond a cubic function curve, and determining an optimum recording power based on the gamma curve when the gamma curve corresponds to a certain function curve below a cubic function curve.

The method may further include re-conducting the OPC procedure based on the determination that noise is originated during the signal recording when the gamma curve is a curve beyond a cubic function curve.

The modulation amplitude may be calculated in accordance with the following equation:

$$m = \frac{\vert Top \vert - \vert Bottom \vert}{\vert Top \vert} ,$$

wherein m is the modulation amplitude, |Top| is a maximum light intensity of the sampled RF signal, and |Bottom| is a minimum light intensity of the sample RF signal.

The certain function below the cubic function may be a linear function and a quadratic function.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawing figures of which:

FIG. 1 is a block diagram illustrating an optical recording and reproducing device according to an embodiment of the present invention;

FIG. 2 is a flowchart describing a method to determine an optimum recording power by analyzing a gamma curve according to an embodiment of the present invention; and

FIGS. 3A and 3B are diagrams of the gamma curve obtained from a modulation amplitude curve at operation 70 of FIG. 2.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

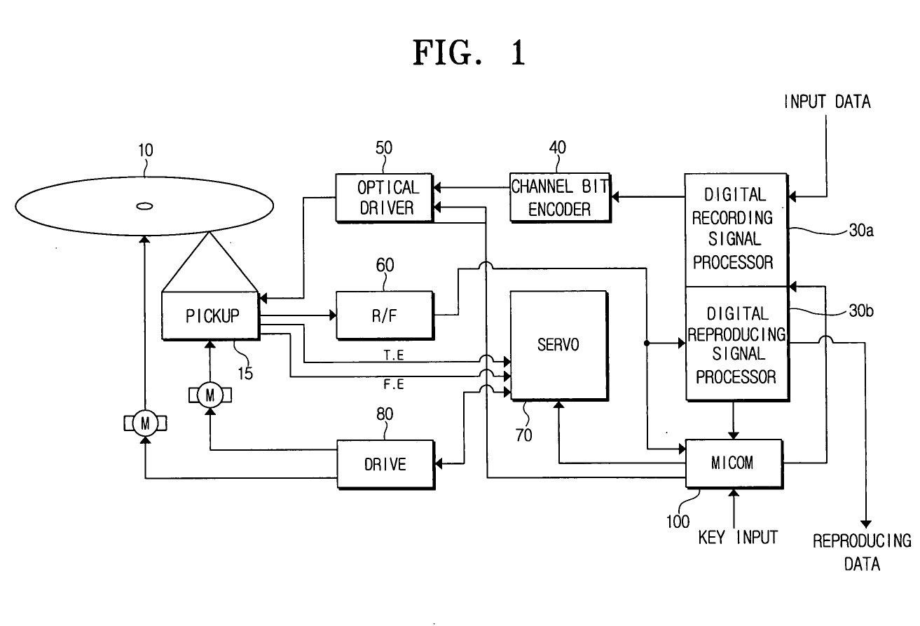

FIG. 1 is a block diagram of an optical recording and reproducing device according to an embodiment of the present invention. In FIG. 1, the optical recording and reproducing device includes a digital recording signal processor 30a, a channel bit encoder 40, an optical driver 50, a pickup 15, a drive 80, a R/F section 60, a servo 70, a digital reproducing signal processor 30b, and a micom 100.

The digital recording signal processor 30a converts input digital data into a recording format by appending an error correction code (ECC), and outputs the recording-formatted data. The channel bit encoder 40 reconverts the recording-formatted data to a bit stream and outputs the bit stream.

The optical driver 50 outputs a light drive signal according to an input signal. The pickup 15 writes a signal on an optical recording medium 10, and reads a signal from the recording area according to the light drive signal provided from the optical driver 50. The drive 80 drives the pickup 15 and a motor M.

The R/F section 60 conducts filtering and waveform shaping for the signal read at the pickup 15, and outputs as a binary signal. The servo 70 controls the operation of the drive 80 based on tracking error (T.E) and focus error (F.E) signals of the pickup 15 and the rotation speed of the optical recording medium 10.

The digital reproducing signal processor 30b restores the binary signal from the R/F section 60 into original data using its own clock synchronized with the binary signal. The micom 100 controls the recording and reproducing operations of the optical recording and reproducing device.

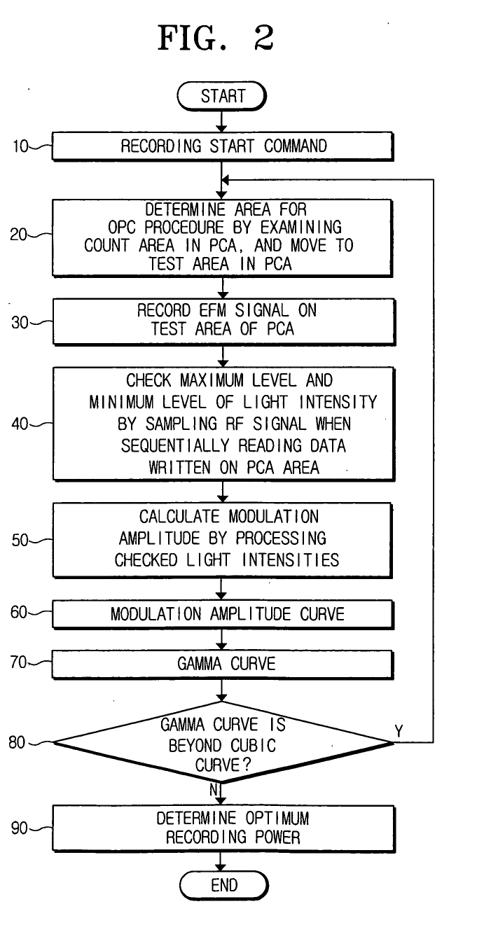

FIG. 2 is a flowchart describing how to determine the optimum recording power by utilizing the analysis of the gamma curve according to an embodiment of the present invention.

In FIG. 2, after the optical recording medium 10 is inserted and loaded on a tray (not shown), when a recording start command for data input from an external source through the micom 100 is received in operation 10, the optimum recording power is detected. The determination of the optimum recording power is described in detail below.

Upon receiving the recording start command in operation 10, before writing the input data, the micom 100 reads a count area in a power calibration area (PCA) of the optical recording medium 10 through the pickup 15, determines the area designated for the OPC procedure, and moves the pickup 15 to a test area included in the PCA in operation 20.

The PCA is reserved at the outermost circumference of the optical disk, and includes an optical disk area and the count area. The test area is divided by 100 partitions. Each partition consists of 16 sectors. One OPC procedure uses one partition and writes a test signal with 16-level laser power with respect to the 16 sectors in the one partition.

Next, the micom 100 reads Absolute Time in Pre-groove (ATIP) information written on the optical recording medium 10, divides the laser recording power into 16 levels based on a power reference recommended by disk manufactures, and writes a random or nT EFM (eight-to-fourteen modulation) signal on the test area in the PCA (S30).

The micom 100 controls the pickup 15 to sequentially read the test data being written on the PCA several times, samples the RF signal that has been read sequentially read and has gone through the filtering and the waveform shaping at the R/F section 60, and checks maximum level and minimum level of the light (S40).

In operation 50, a modulation amplitude m is obtained from the checked light intensities in accordance with Equation 1.

$$m = \frac{\vert Top \vert - \vert Bottom \vert}{\vert Top \vert} \qquad [ Equation 1 ]$$

In Equation 1, m is the modulation amplitude, |Top| is the maximum light intensity of the sampled RF signal, and |Bottom| is the minimum light intensity of the sampled RF signal.

Next, in operation 60, a polynomial expression for a modulation amplitude curve m=f(p) is estimated from the modulation amplitude of the recording powers obtained at operation 50 using a curve fitting.

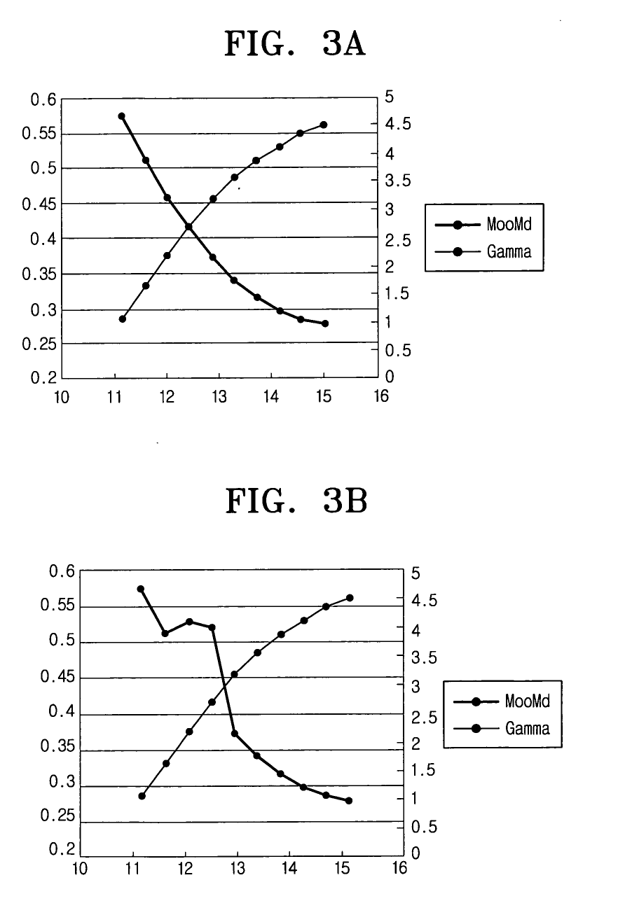

A gamma curve is derived from the estimated modulation amplitude curve m=f(p) (S70), which is illustrated in FIG. 3. In FIG. 3, MooMd represents the modulation amplitude curve, and Gamma represents the gamma curve. Particularly, FIG. 3A depicts a case when the gamma curve does not correspond to a higher-order function over a cubic function, and FIG. 3B depicts a case when the gamma curve corresponds to a higher-order function over the cubic function.

The gamma curve is a normalized slope of the function m, and is expressed as the following Equation 2.

$$γ = \frac{ⅆ m}{ⅆ Pw} \cdot \frac{Pw}{m} \qquad [ Equation 2 ]$$

In Equation 2, γ is expressed in relation with the modulation amplitude variation and the recording power variation. Pw is the recording power applied on the test area.

Next, in operation 80, it is determined whether the gamma curve obtained at operation 70 corresponds to a higher-order function over a cubic function.

If the gamma curve corresponds to the higher-order function curve over the cubic function as shown in FIG. 3B, the presence of noise during the signal recording is determined and operation 20 is repeated to conduct the OPC procedure. This is because the presence of noise during the signal recording obstructs the accurate determination of the optimum recording power.

In operation 80, if the gamma curve corresponds to the higher-order function curve below the cubic function as shown in FIG. 3A, that is, if noise is absent during the signal recording, the optimum recording power is determined as represented in equation 3 (operation 90). Herein, a function below the cubic function is the linear function or the quadratic function.

The optimum recording power P_{O} can be determined from the gamma curve in FIG. 3 by multiplying a recording power P_{target} corresponding to a predetermined target gamma γₜ by a multiplication factor ρ.
P_{O}=ρ×P_{target} [Equation 3]

In Equation 3, the target gamma γₜ and the multiplication factor τ, together with the power reference, are predetermined and encoded in special information of the ATIP on a lead-in area at the time of the disk manufacture. These values may vary depending on the disk types and disk manufactures.

The optimum recording power acquired based on Equation 3 is set to the recording power for the signal recording. Specifically, the micom 100 controls the optical driver 50 to output the recording signal with respect to the input data according to the optimum optical drive current determined as above. The optical driver 50 issues the signal according to the optical drive power to the pickup 15 so that the signal having the modulated pulse width is recorded on the optical recording medium 10.

As recording the data, the micom 100 determines the type of the recording signal, that is, the micom 100 determines the level and the width of the pulse based on the recording method that is written as a fixed value to the optical recording medium 10 at the time of the manufacture. For example, an optical recording medium allowing only one recording has a fixed log value for the individual medium type, and a rewritable optical recording medium has a fixed log value for the respective recording speeds. Hence, the data is converted to the recording signal, that is, converted to the recording pulse at the determined optimum recording light power based on the type of the recording signal, and then is written on the optical recording medium 10.

As described above, if the gamma curve obtained through the OPC procedure corresponds to a higher-order function curve over a cubic function, the presence of the noise is determined and the OPC procedure is re-conducted. Therefore, it is possible to determine the optimum recording power with more accuracy during the OPC procedure.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method for determining an optimum recording power by using the analysis of a gamma curve, comprising:
receiving a data recording start command;
determining an area to conduct an optimum power control (OPC) procedure by examining a count area in a power calibration area (PCA) of an optical recording medium, and recording an eight-to-fourteen modulation (EFM) signal on a test area included in the PCA;
calculating a modulation amplitude based on a maximum level of a light intensity and a minimum level of a light intensity that are obtained by sampling an RF signal generated when test data being written on the PCA several times are retrieved in sequence, and estimating a modulation amplitude curve from the modulation amplitude using a curve fitting;
deriving a gamma curve from the modulation amplitude curve, and determining whether the derived gamma curve corresponds to a higher-order function curve beyond a cubic function curve; and
determining an optimum recording power based on the gamma curve when the gamma curve corresponds to a predetermined function curve below a cubic function curve.

2. The method according to claim 1, further comprising re-conducting the OPC procedure based on the determination that noise is originated during the signal recording when the gamma curve is a curve beyond a cubic function curve.

3. The method according to claim 1, wherein the modulation amplitude is calculated in accordance with the following equation:
$$m = \frac{\vert Top \vert - \vert Bottom \vert}{\vert Top \vert} ,$$
wherein m is the modulation amplitude, |Top| is a maximum light intensity of the sampled RF signal, and |Bottom| is a minimum light intensity of the sample RF signal.

4. The method according to claim 1, wherein the predetermined function below the cubic function is a linear function and a quadratic function.

5. A method for determining an optimum recording power by using the analysis of a gamma curve, comprising:
deriving a gamma curve from a modulation amplitude curve, and determining whether the derived gamma curve corresponds to a higher-order function curve beyond a cubic function curve; and
determining an optimum recording power based on the gamma curve when the gamma curve corresponds to a certain function curve below a cubic function curve.

6. The method according to claim 5, further comprising conducting an optimum power control (OPC) procedure based on a determination that noise is originated during a signal recording when the gamma curve is a curve beyond a cubic function curve.

7. An apparatus to determine an optimum recording power by using the analysis of a gamma curve, comprising:
a digital recording signal processor to convert input digital data into a recording format and outputting said recording-formatted data;
an encoder to reconvert the recording-formatted data to a bit stream and outputting the bit stream;
an optical driver to output a light drive signal in correspondence to an input signal;
a pickup unit to write a signal on an optical recording medium, and to read a signal according to said light drive signal;
a drive unit to drive said pickup unit;
an R/F unit to conduct filtering and waveform shaping of the write signal of said pickup unit and output a resulting binary signal;
a servo to control the operation of said drive unit;
a digital reproducing signal processor to restore said binary signal from said R/F unit into original data using its own clock synchronized with said binary signal; and
a micom to control said recording and reproducing processors.
